(19) United States
(12) Patent Application Publication
(10) Pub. No.: US 2004/0016068 A1
(43) Pub. Date: Jan. 29, 2004

(54) Electric toothbrush

(75) Inventor: Ka Fai Lee, Yuen Long (HK)

Correspondence Address: Hall, Priddy, Myers and Vande Sande, Suite 200, 10220 River Road, Potomac, MD, 20854, US

(73) Assignee: SUN LUEN ELECTRICAL MFG. CO. LTD., Kowloon (HK)

(21) Appl. No.: 10/391,187

(22) Filed: Mar. 19, 2003

Related U.S. Application Data
(63) Continuation-in-part of application No. 10/202,678, filed on Jul. 25, 2002.

(51) Int. Cl. A61C 17/34

(52) U.S. Cl. 15/22.1; 15/28

(57) ABSTRACT

An electric toothbrush (10, 100) is disclosed as including an electric motor (22, 122), a shaft (56, 156) engaged with a brush head (18), and a coupling mechanism operatively associated with the motor (22, 122) and the shaft (56, 156) for coupling with the motor (22, 122) to drive the shaft (56, 156) to swivel about a longitudinal axis of the shaft (56, 156), the coupling mechanism including a reciprocating block (34, 134) reciprocable along a straight line perpendicular to the longitudinal axis of the shaft (56, 156).

This is a Continuation-In-Part of U.S. patent application Ser. No. 10/202,678 filed on Jul. 25 2002.

This invention relates to an electric toothbrush, and in particular, such a toothbrush with a shaft adapted to be engaged with a brush head, and to swivel about its longitudinal axis.

### BACKGROUND OF THE INVENTION

There are many different constructions of electric toothbrushes. In such existing electric toothbrushes, a coupling mechanism is arranged between an electric motor and a shaft to which a brush head is attached, so that the output of an output spindle of the motor is transmitted to cause the shaft, and thus the brush head, to perform a brushing movement. Conventional coupling mechanisms are usually rather complicated and, given the relatively small size of an electric toothbrush, costly to produce.

It is thus an object of the present invention to provide a new electric toothbrush with a coupling mechanism of a relatively simple construction, and is thus less costly to manufacture, or at least to provide a useful alternative to the public.

### SUMMARY OF THE INVENTION

According to the present invention, there is provided an electric toothbrush including an electric motor, a shaft member adapted to be engaged with a brush member, and a coupling mechanism operatively associated with said motor and said shaft member for coupling with said motor to drive said shaft member to swivel substantially about a longitudinal axis of said shaft member, wherein said coupling mechanism includes a movable member adapted to reciprocate along a substantially straight line which is substantially perpendicular to said longitudinal axis of said shaft member.

### BRIEF DESCRIPTION OF THE DRAWINGS

Preferred embodiments of an electric toothbrush according to the present invention will now be described, by way of examples only, and by reference to the accompanying drawings, in which:

FIG. 1 is a front perspective view of an electric toothbrush according to the present invention;

FIG. 2A is an enlarged exploded view of a first coupling mechanism suitable for use in the electric toothbrush shown in FIG. 1;

FIG. 2B is a further enlarged exploded view of the coupling mechanism shown in FIG. 2A with the top-open container removed;

FIG. 3A is a top view of the reciprocating block of the coupling mechanism shown in FIG. 2A;

FIG. 3B is a front view of the reciprocating block shown in FIG. 3A;

FIG. 3C is a bottom view of the reciprocating block shown in FIG. 3A;

FIG. 3D is a side view of the reciprocating block shown in FIG. 3A;

FIGS. 4A to 4D are top views of the relative positions of the components of the coupling mechanism shown in FIG. 2A during various stages of the operation of the electric toothbrush shown in FIG. 1;

FIG. 5A is an enlarged exploded view of a second coupling mechanism of suitable for use in the electric toothbrush shown in FIG. 1;

FIG. 5B is a further enlarged exploded view of the coupling mechanism shown in FIG. 5A with the top-open container removed;

FIG. 6A is a top view of the reciprocating block of the coupling mechanism shown in FIG. 5A;

FIG. 6B is a side view of the reciprocating block shown in FIG. 6A;

FIG. 6C is a front view of the reciprocating block shown in FIG. 6A;

FIG. 6D is a bottom view of the reciprocating block shown in FIG. 6A;

FIG. 7A is a top view of the swiveling block of the coupling mechanism shown in FIG. 5A;

FIG. 7B is a side view of the swiveling block shown in FIG. 7A;

FIG. 7C is a front view of the swiveling block shown in FIG. 7A;

FIG. 7D is a bottom view of the swiveling block shown in FIG. 7A; and

FIGS. 8A to 8D are top views of the relative positions of the components of the coupling mechanism shown in FIG. 5A during various stages of the operation of the coupling mechanism shown in FIG. 5A.

### DETAILED DESCRIPTION OF THE PREFERRED EMBODIMENTS

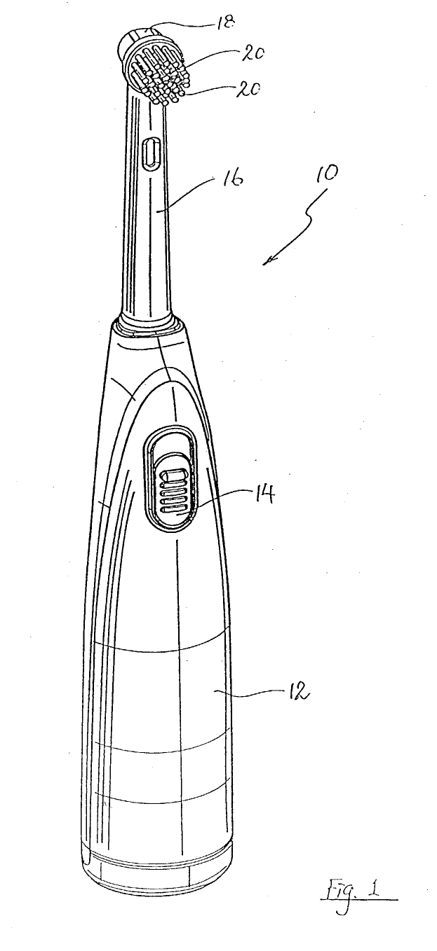

FIG. 1 shows a front perspective view of an electric toothbrush according to a first embodiment of the present invention, generally designated as 10. The toothbrush 10 includes an elongate handle 12 including a slidable button 14 operable to activate or deactivate the toothbrush 10, as desired. Extending from an upper end of the handle 12 is a hollow elongate tube 16, which leads to a brush head 18, with a number of bristles 20 for brushing. The brush head 18 is fixedly engaged with a shaft (to be discussed below) which extends through the hollow elongate tube 16 into the interior of the toothbrush 10 for engagement with a first coupling mechanism, to be discussed below. Housed in the handle 12 is a motor (to be discussed below) powerable by one or more dry batteries (not shown) also contained in the handle 12, or by an a.c. source.

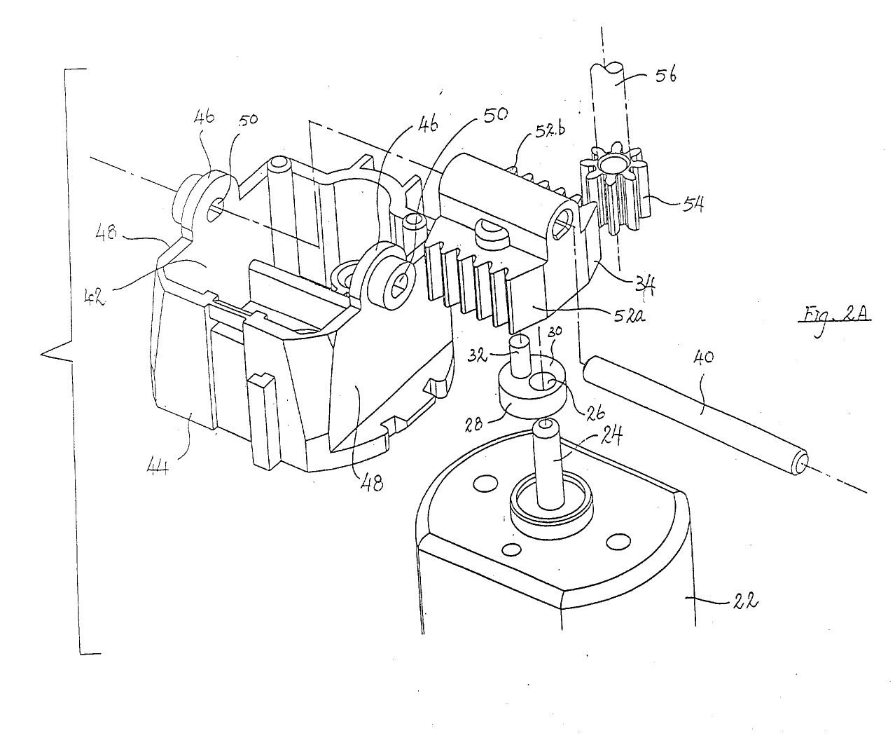

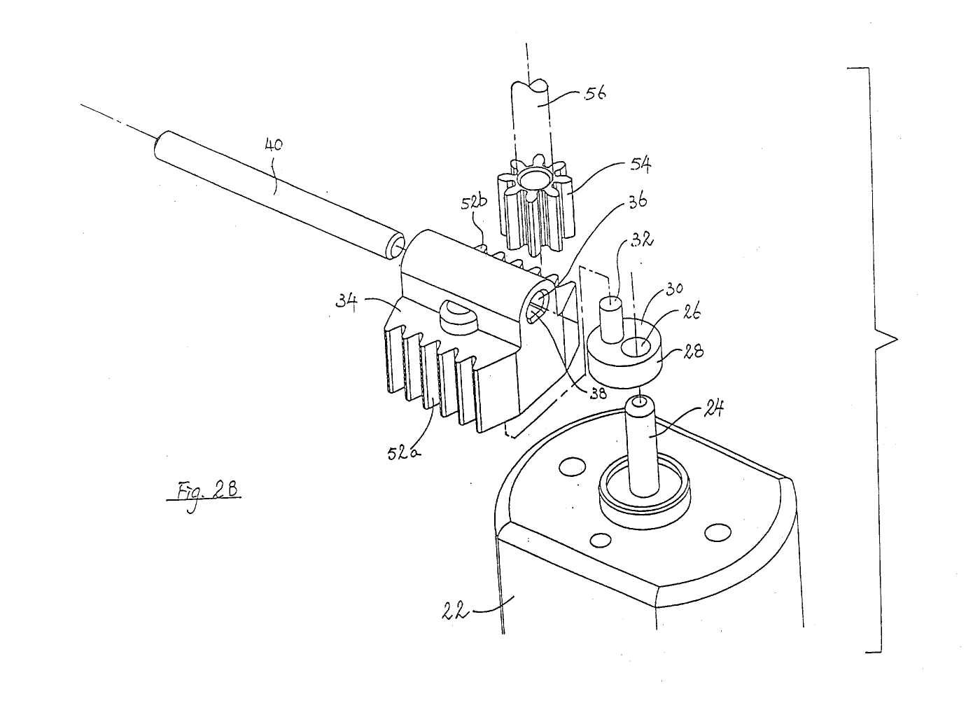

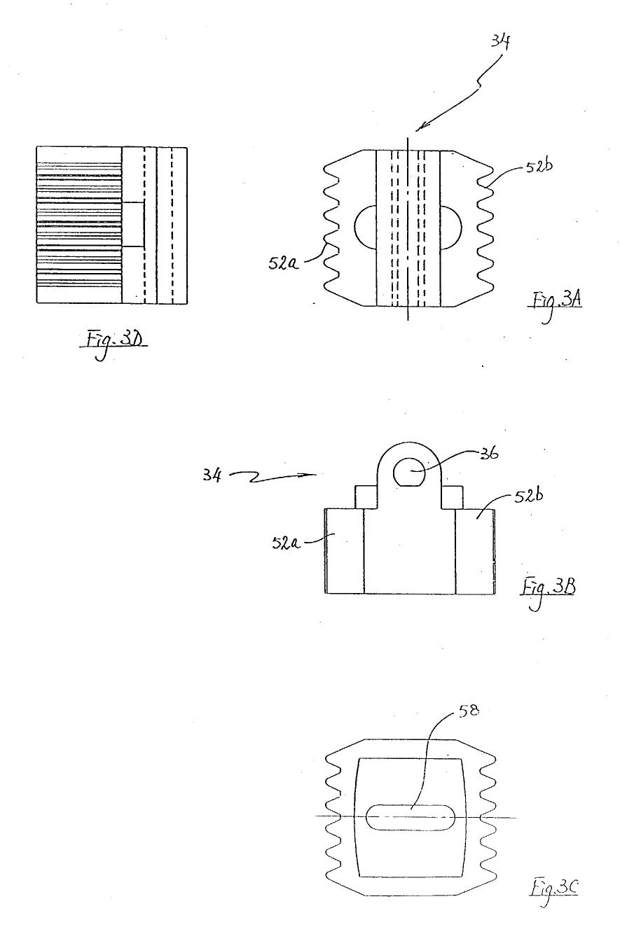

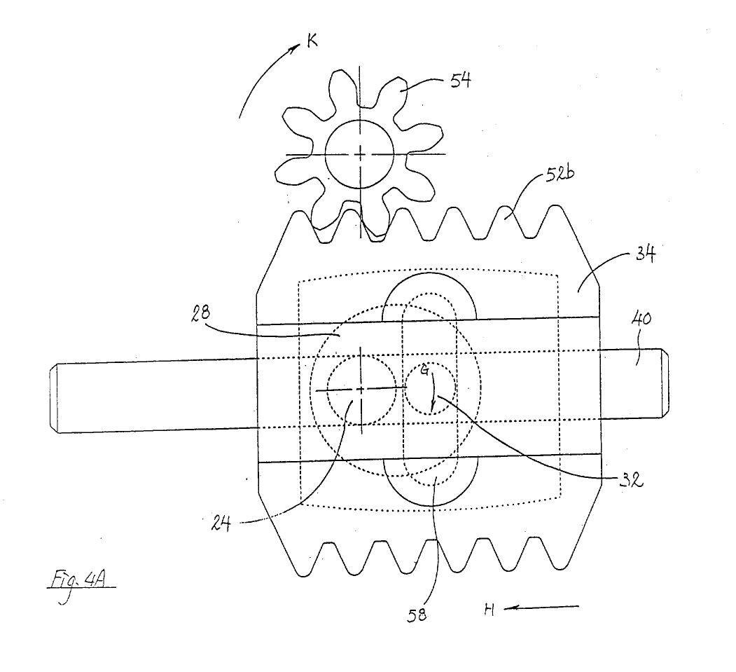

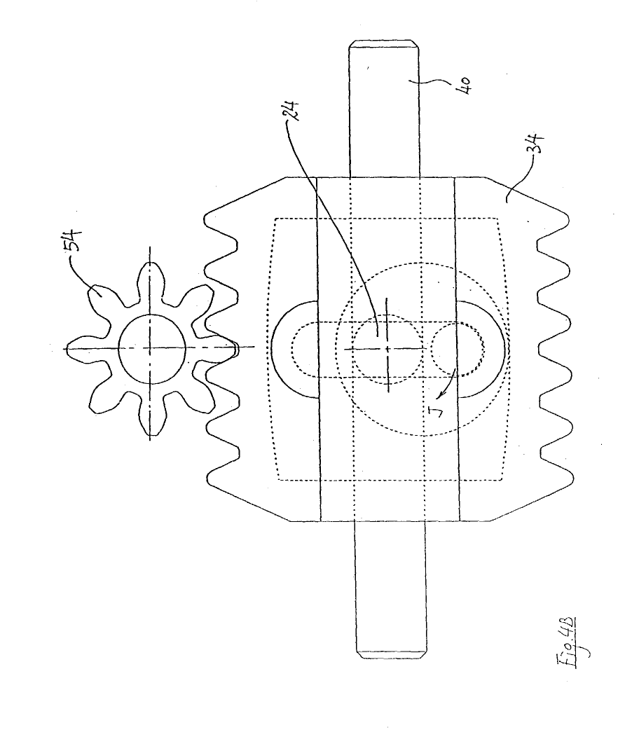

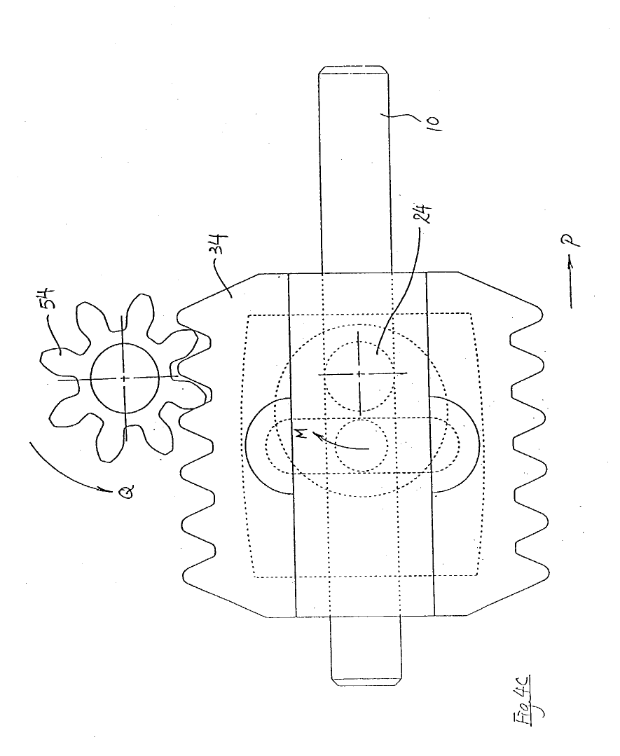

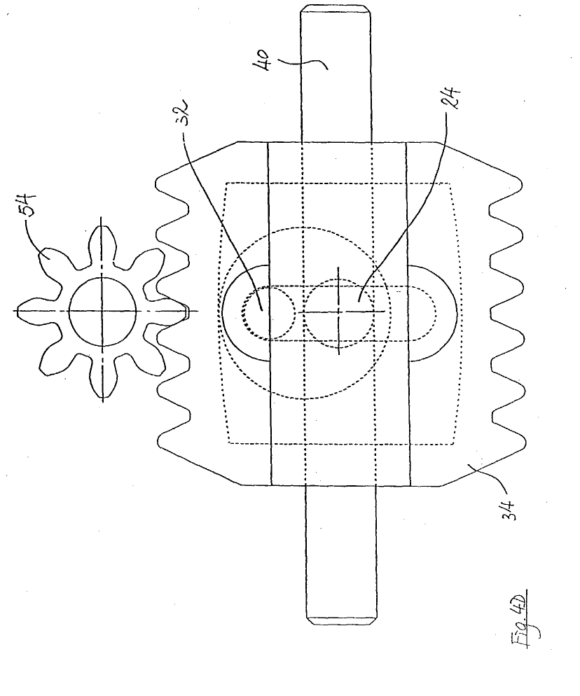

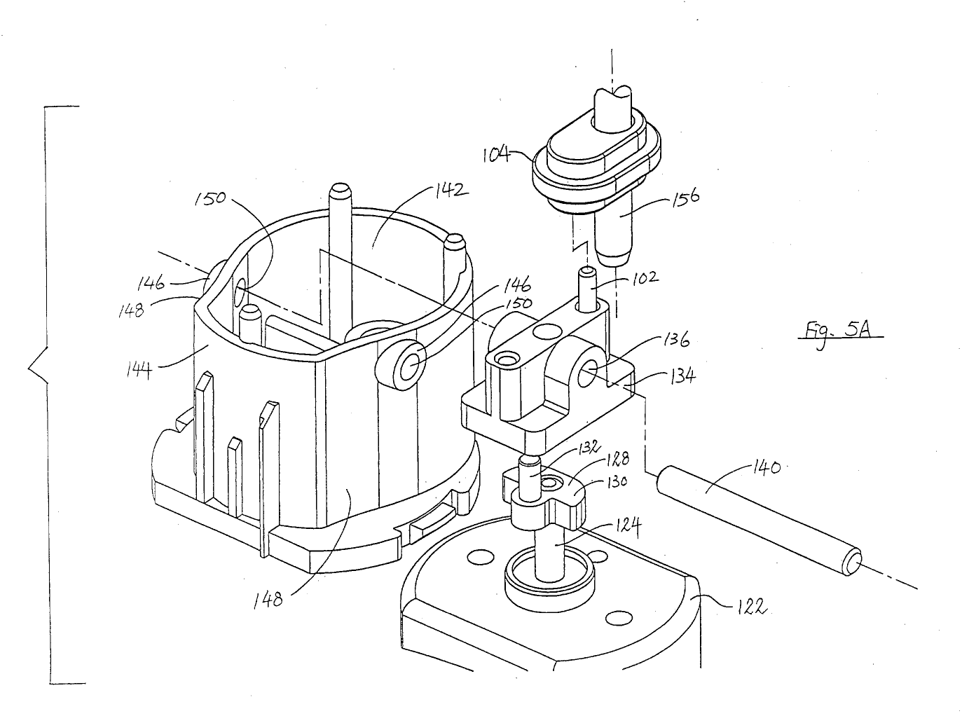

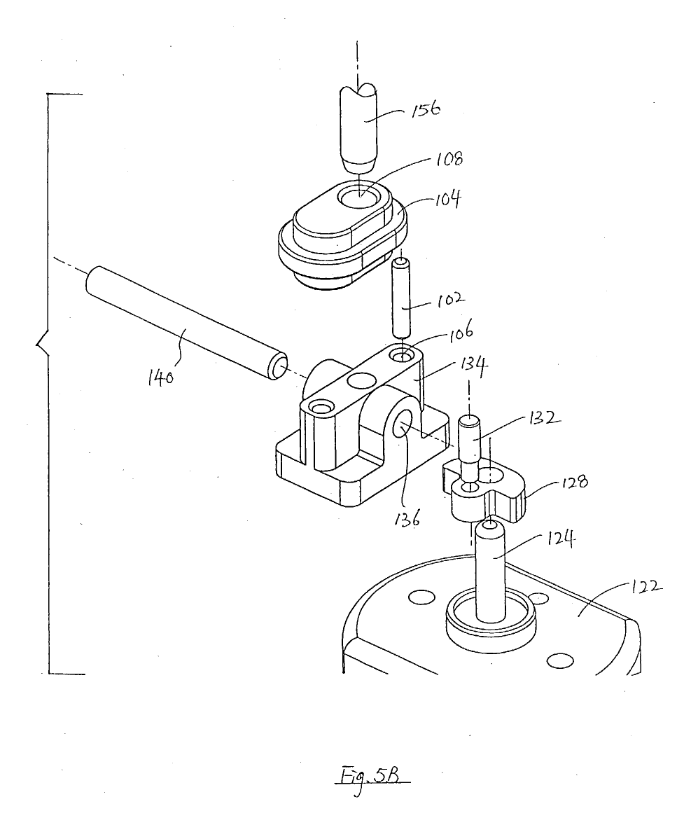

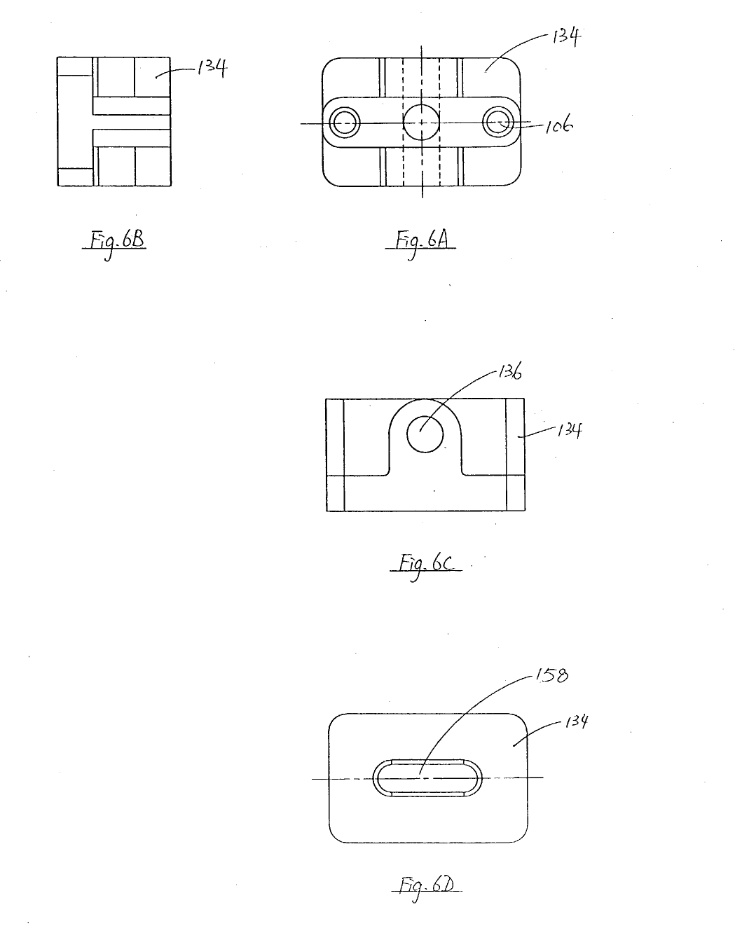

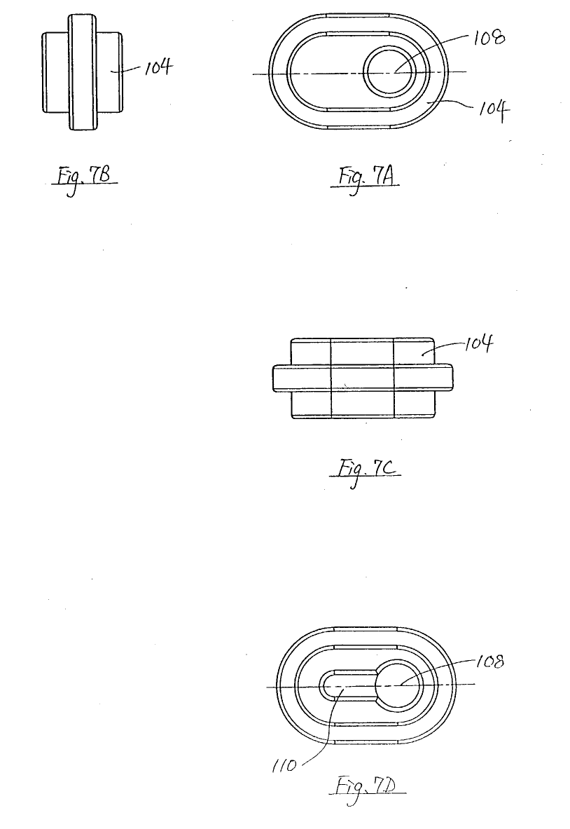

As shown in FIGS. 2A and 2B, an electric motor 22 housed in the handle 12 has an output spindle 24 which is fixedly fitted in an opening 26 of a revolving disc 28. Extending from and fixedly secured with an upper surface 30 of the disc 28 is a pin 32, which is received within an underside of a reciprocating block 34, in a manner to be discussed below. It can be seen that, when the motor 22 is activated, rotation of the spindle 24 will cause the disc 28 and the accompanying pin 32 to revolve about the longitudinal axis of the spindle 24.

The reciprocating block 34 has, on its upper part, a channel 36 running along its length. The channel 36 is generally circular in shape, but with a flat bottom surface 38. A correspondingly sized and shaped generally cylindrical rod 40 is received within the channel 36. As the rod 40 also has a partly flat outer surface which abuts the flat bottom surface 38 of the channel 36, the block 34 may only slide relative to the rod 40 along its length, with no relative swivelling or rotational movement. Although it is preferred to provide a flat bottom surface 38 in the channel 36 and a partly flat outer surface on the rod 40 which complement with each other, both flat surfaces may be dispensed with without significantly affecting the performance of the coupling mechanism.

As shown in FIG. 2A, the block 34 is hung and received within a cavity 42 of a top-open container 44 by the rod 40 for reciprocating movement. In particular, the container 44 has two ears 46 positioned on the upper edge of two opposite side walls 48. Each ear 46 has a hole 50 shaped and sized as the channel 36 of the reciprocating block 34. Thus, when the block 34 is placed in the cavity 42 of the container 44, the rod 40 may be inserted through a hole 50 of one ear 46, then through the channel 36, and subsequently through the hole 50 of another ear 46. By way of such an arrangement, the block 34 is hung within the cavity 42 for reciprocating movement relative to the rod 40, and along an axis parallel to the length of the rod 40.

On each lateral side of the block 34 is a row of gear teeth 52a, 56b. The gear teeth 52b are in mesh with a gear 54 fixed to a shaft 56. The brush head 18 is fixedly engaged with an upper end of the shaft 56 for simultaneous movement. By way of such an arrangement, reciprocating movement of the block 34 will set the shaft 56, and thus the brush head 18, into swivelling movement about its longitudinal axis. It can also be seen that the longitudinal axis of the shaft 56 is perpendicular to the rod 40.

FIGS. 3A to 3D show various views of the reciprocating block 34. As can be seen more particularly in FIG. 3C, an elongate recess 58 is formed on an underside of the block 34 for receiving part of the pin 32 of the disc 28. The recess 58 is of a width that is the same or slightly larger than the diameter of the pin 32, to allow sliding movement of the pin 32 relative to the recess 58. It can also be seen that the length of the recess 58 is perpendicular to the length of the block 34.

FIGS. 4A to 4D show respective plan views of the relative position between the gear 54, the block 34, the rod 40 and the revolving disc 28 of the toothbrush 10. It should be pointed out that the position of the longitudinal axis of the shaft 56, and thus of the gear 54, the longitudinal axis of the output spindle 24 of the motor 22, and the rod 40 are fixed relative to one another.

FIG. 4A shows the block 34 in the right-most position relative to the rod 40. When the motor 22 is activated, the spindle 24 rotates so that the pin 32 of the disc 28 revolves around the longitudinal axis of the spindle 24 in the direction indicated by the arrow G, until the pin 32 reaches the position shown in FIG. 4B. As the pin 32 is confined within the recess 58 of the block 34, and the movement of the block 34 is confined by the rod 40, the block 34 will slide relative to the rod 40 in the direction indicated by the arrow H, thus causing the gear 54, and the shaft 56 with which the gear 54 is secured, to rotate in the direction indicated by the arrow K. When the spindle 24 further rotates, the pin 32 will revolve around the spindle 24 in the direction indicated by the arrow J shown in FIG. 4B, until the pin 32 reaches the position shown in FIG. 4C. It can be seen that the block 34 has moved further relative to the rod 40 in the direction of the arrow H, and the gear 54 has rotated further in the direction indicated by the arrow K. In particular, in the position shown in FIG. 4C, the block 34 is in the left-most position relative to the rod 40.

When the pin 32 further revolves around the spindle 24 in the direction shown by the arrow M in FIG. 4C, the block 34 will start to move in the direction shown by the arrow P in FIG. 4C, which is opposite to the direction indicated by the arrow H in FIG. 4A, and the gear 54 will start to rotate about its own longitudinal axis in the direction indicated by the arrow Q, which is opposite to the direction indicated by the arrow K in FIG. 4A. Further rotation of the pin 32 relative to the spindle 24 in the direction of the arrow M shown in FIG. 4C will bring the pin 32 to the position shown in FIG. 4D, thus causing the block 34 to slide relative to the rod 40 further in the direction indicated by the arrow P, which in turn causes the gear 54 to rotate further about its longitudinal axis in the direction indicated by the arrow Q. Further rotation of the spindle 24 in the same direction will bring the pin 32 back to the position shown in FIG. 4A, thus completing a cycle of rotational movement.

It can be seen that, by way of the coupling mechanism discussed above, upon activation of the motor 22, the spindle 24 will rotate, thus causing the block 34 to reciprocate along the rod 40, which in turn causes the gear 54, and the brush head 18 fixed thereto, to swivel back and forth about the longitudinal axis of the shaft 56.

A second coupling mechanism suitable for use in an electric toothbrush according to the present invention is shown in FIGS. 5A and 5B. An electric motor 122 housed inside the toothbrush has an output spindle 124 which is fixedly fitted with a revolving block 128 for simultaneous rotational movement. Extending from and fixed with an upper surface 130 of the block 128 is a pin 132, which is received within an underside of a reciprocating block 134, in a manner to be discussed below. When the motor 122 is activated, rotation of the spindle 124 will cause the revolving block 128 and the accompanying pin 132 to revolve about the longitudinal axis of the spindle 124.

The reciprocating block 134 has a generally circular channel 136 running through its body. A correspondingly sized and shaped generally cylindrical rod 140 is received within the channel 136, for allowing the block 134 to slide relative to the rod 140.

The block 134 is hung and received within a cavity 142 of a top-open container 144 by the rod 140 for reciprocating movement. In particular, the container 144 has two ears 146 positioned on the upper edge of two opposite side walls 148. Each ear 146 has a hole 150 shaped and sized as the channel 136 of the reciprocating block 134. Thus, when the block 134 is placed in the cavity 142 of the container 144, the rod 140 may be inserted through a hole 150 of one ear 146, then through the channel 136, and subsequently through the hole 150 of another ear 146. By way of such an arrangement, the block 134 is hung within the cavity 142 for reciprocating movement relative to, and along an axis parallel to the length of, the rod 140.

A pin 102 is received within a hole 106 of the block 134 for simultaneous reciprocating movement with the block 134. The pin 102 extends upward from the reciprocating block 134, and its top end is received within an underside of a swiveling block 104 for relative movement, in a manner to be discussed below. A shaft 156 is fixedly received within a hole 108 of the swiveling block 104 for simultaneous swiveling movement. A brush head (not shown) is fixedly engaged with an upper end of the shaft 156 for simultaneous movement. By way of such an arrangement, reciprocating movement of the block 134 will set the shaft 156, and thus the brush head, into swiveling movement about its longitudinal axis. It can also be seen that the longitudinal axis of the shaft 156 is perpendicular to the rod 140.

FIGS. 6A to 6D show various views of the reciprocating block 134. As can be seen more particularly in FIG. 6D, an elongate recess 158 is formed on an underside of the block 134 for receiving part of the pin 132 of the revolving block 128. The recess 158 is of a width that is the same or slightly larger than the diameter of the pin 132, to allow sliding movement of the pin 132 relative to the recess 158.

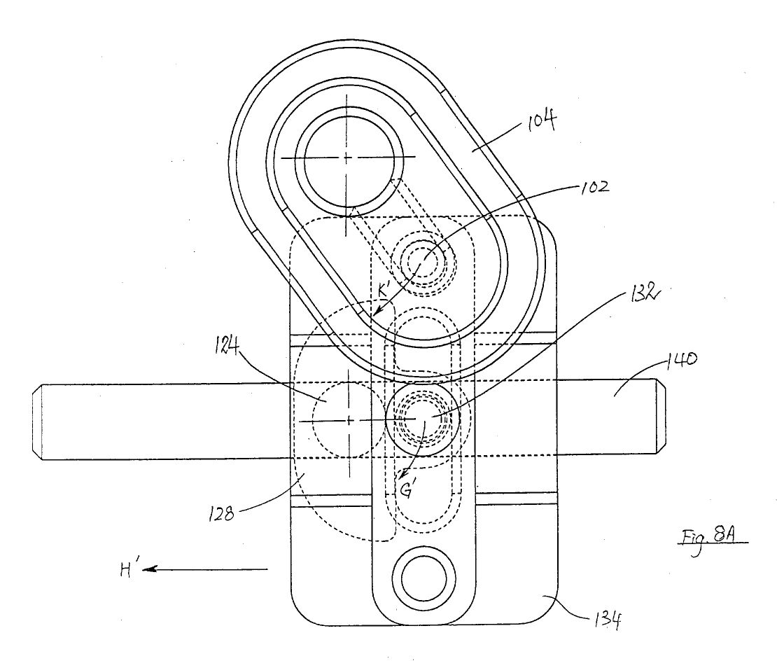

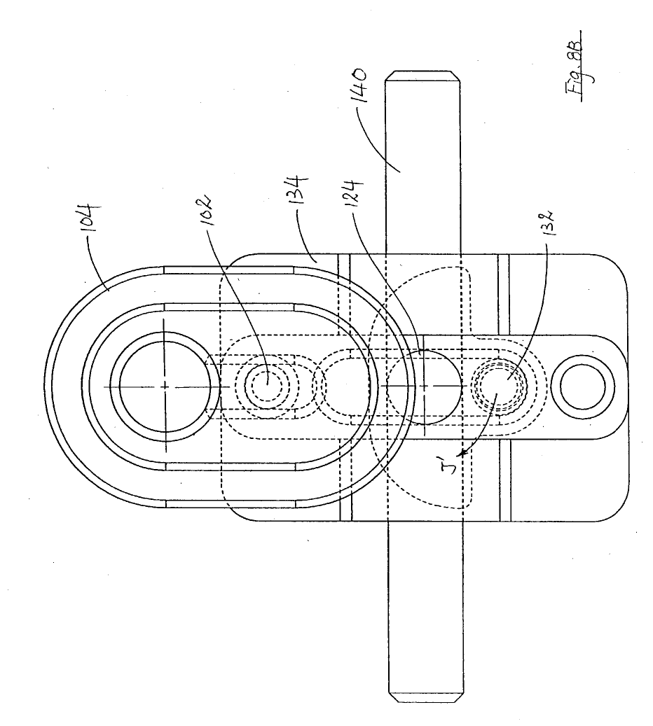

FIGS. 7A to 7D show various views of the swiveling block 104. As can be seen more clearly in FIG. 7D, an elongate recess 110 is formed on an underside of the block 104 for receiving the upper end of the pin 102 extending from the reciprocating block 134. The recess 110 is of a width that is the same or slightly larger than the diameter of the pin 102, to allow sliding movement of the pin relative to the recess 110. It can be seen that the recess 110 is parallel to the length of the swiveling block 104.

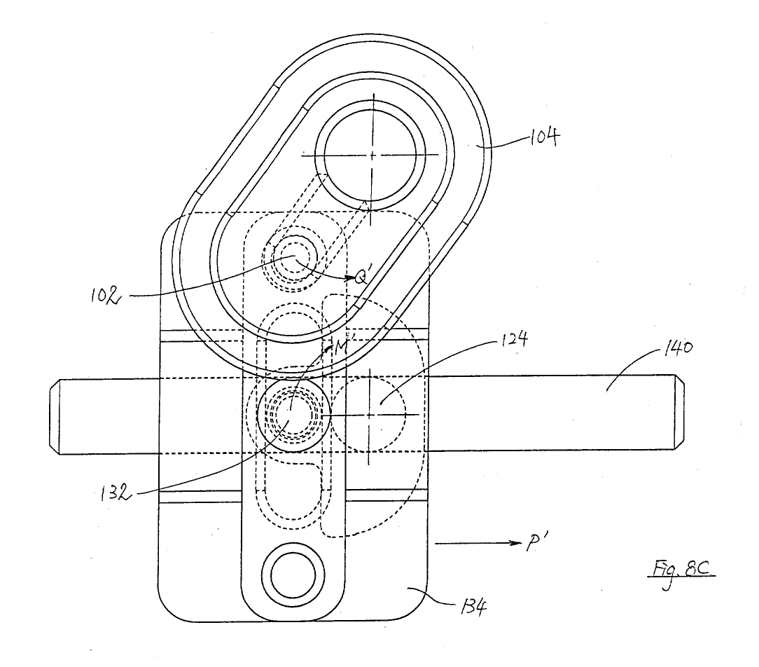

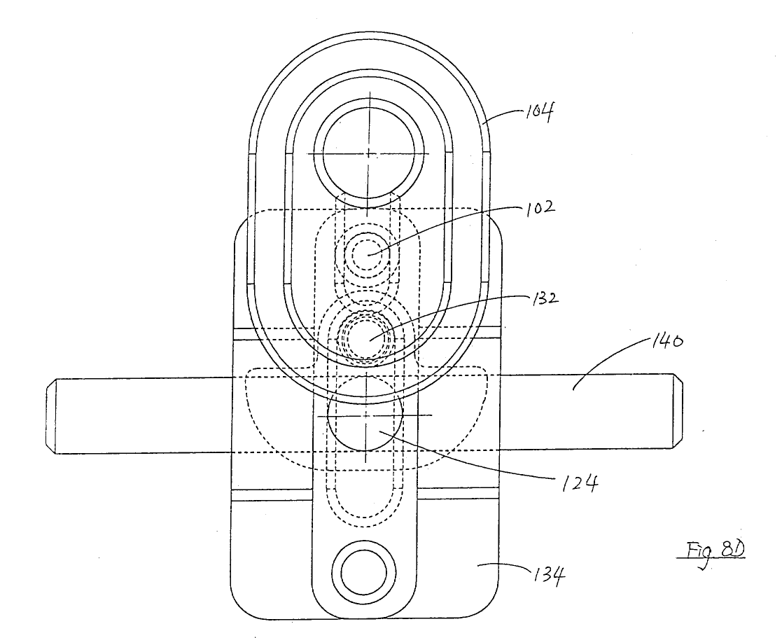

FIGS. 8A to 8D show respective plan views of the relative position between the swiveling block 104, the reciprocating block 134, the rod 140 and the revolving block 128 (shown in dashed line) of the toothbrush. It should be pointed out that the position of the longitudinal axis of the shaft 156, the longitudinal axis of the output spindle 124 of the motor 122, and the rod 140 are fixed relative to one another.

FIG. 8A shows the block 134 in the right-most position relative to the rod 140. When the motor 122 is activated, the spindle 124 rotates so that the pin 132 of the block 128 revolves about the longitudinal axis of the spindle 124 in the direction indicated by the arrow G′, until the pin 132 reaches the position shown in FIG. 8B. As the pin 132 is confined within the recess 158 of the reciprocating block 134, and the movement of the block 134 is confined by the rod 140, the block 134 will slide relative to the rod 140 in the direction indicated by the arrow H′. The movement of the block 134 will cause the pin 102 to also move in the direction indicated by the arrow H′. Because of the confinement of the pin 102 in the recess 110 of the swiveling block 104, the swiveling block 104, and thus the shaft 156 with which it is secured, will be caused to swivel in the direction indicated by the arrow K′ about the axis of the shaft 156.

When the spindle 124 further rotates, the pin 132 will revolve around the spindle 124 in the direction indicated by the arrow J′ shown in FIG. 8B, until the pin 132 reaches the position shown in FIG. 8C. It can be seen that the block 134 has moved further relative to the rod 140 in the direction of the arrow H′, and the swiveling block 104 has rotated further in the direction indicated by the arrow K′. In particular, in the position shown in FIG. 8C, the block 134 is in the left-most position relative to the rod 140.

When the pin 132 further revolves around the spindle 124 in the direction shown by the arrow M′ in FIG. 8C, the block 134 will start to move in the direction shown by the arrow P′ in FIG. 8C, which is opposite to the direction indicated by the arrow H′ in FIG. 8A, and the swiveling block 104 will start to rotate about the longitudinal axis of the shaft 156 in the direction indicated by the arrow Q′, which is opposite to the direction indicated by the arrow K′ in FIG. 8A. Further rotation of the pin 132 relative to the spindle 124 in the direction of the arrow M′ shown in FIG. 8C will bring the pin 132 to the position shown in FIG. 8D, thus causing the reciprocating block 134 to slide relative to the rod 140 further in the direction indicated by the arrow P′, which in turn causes the swiveling block 104 to rotate further about the longitudinal axis of the shaft 156 in the direction indicated by the arrow Q′. Further rotation of the spindle 124 in the same direction will bring the pin 132 back to the position shown in FIG. 8A, thus completing a cycle of rotational movement.

It can be seen that, by way of the coupling mechanism discussed above, upon activation of the motor 122, the spindle 124 will rotate, thus causing the block 134 to reciprocate along the rod 140, which in turn causes the swiveling block 104, and the brush head fixed thereto, to swivel back and forth about the longitudinal axis of the shaft 156.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

What is claimed is:

1. An electric toothbrush including an electric motor, a shaft member adapted to be engaged with a brush member, and a coupling mechanism operatively associated with said motor and said shaft member for coupling with said motor to drive said shaft member to swivel substantially about a longitudinal axis of said shaft member, wherein said coupling mechanism includes a movable member adapted to reciprocate along a straight line which is substantially perpendicular to said longitudinal axis of said shaft member.

2. An electric toothbrush according to claim 1 wherein said shaft member is fixed with a gear member in mesh with a geared portion of said movable member.

3. An electric toothbrush according to claim 1 wherein said movable member includes a channel member for receiving a rod member, and wherein said movable member is adapted to reciprocate relative to said rod member.

4. An electric toothbrush according to claim 1 wherein said movable member is received and movable within a cavity of a containing member.

5. An electric toothbrush according to claim 4 wherein said movable member is engaged with said containing member via a rod member relative to which said movable member is movable.

6. An electric toothbrush according to claim 1 wherein an output spindle of said motor is engaged with a revolving member with a pin member adapted to revolve around the output spindle of said motor.

7. An electric toothbrush according to claim 6 wherein at least part of said pin member of said revolving member is received within an elongate recess on an underside of said movable member.

8. An electric toothbrush according to claim 7 wherein said recess has a length which is substantially perpendicular to the straight line along which said movable member is adapted to reciprocate.

9. An electric toothbrush according to claim 1 wherein said shaft member is fixed with a swiveling member engaged with said movable member via at least a pin member.

10. An electric toothbrush according to claim 9 wherein said pin member is engaged with both said swiveling member and said movable member.

11. An electric toothbrush according to claim 9 wherein at least part of said pin member of said movable member is received within a recess on an underside of said swiveling member.
